(19) United States
(12) Patent Application Publication
(10) Pub. No.: US 2025/0157153 A1
(43) Pub. Date: May 15, 2025

(54) METHOD AND APPARATUS FOR REMOVING UNWANTED POINTS FROM POINT CLOUDS

(71) Applicant: FARO Technologies, Inc., Lake Mary, FL (US)

(72) Inventors: Raphael Espanha, Porto (PT); Hooshiar Zolfagharnasab, Porto (PT); Jamie Duarte Rodrigues, Porto (PT)

(21) Appl. No.: 18/921,808

(22) Filed: Oct. 21, 2024

Related U.S. Application Data
(60) Provisional application No. 63/591,952, filed on Oct. 20, 2023.

(51) Int. Cl. G06T 19/00

(52) U.S. Cl. CPC G06T 19/00; G06T 2210/04

(57) ABSTRACT

An example method for removing an unwanted point from a point cloud is provided. The method includes grouping points of the point cloud based on a frequency of occurrence of the points relative to a vertical axis defined for an environment. The method further includes identifying a first set of points corresponding to an upper boundary of the environment and identifying a second set of points corresponding to a lower boundary of the environment. The method further includes generating a revised point cloud. The revised point cloud excludes points above the upper boundary and points below the lower boundary.

### CROSS-REFERENCE TO RELATED APPLICATIONS

This application claims the benefit of U.S. Provisional Patent Application No. 63/591,952 filed Oct. 20, 2023, the disclosure of which is incorporated herein by reference in its entirety.

### BACKGROUND

The subject matter disclosed herein relates to use of a three-dimensional (3D) coordinate measurement device, such as a laser scanner time-of-flight (TOF) coordinate measurement device referred to as a “TOF scanner,” “3D laser scanner,” and “laser scanner.” A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They are also used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

### BRIEF DESCRIPTION

In one embodiment, a method for removing an unwanted point from a point cloud of an environment is provided. The method includes grouping points of the point cloud based on a frequency of occurrence of the points relative to a vertical axis defined for the environment. The method further includes identifying a first set of points of the point cloud corresponding to an upper boundary of the environment based at least in part on the frequency of occurrence. The method further includes identifying a second set of points of the point cloud corresponding to a lower boundary of the environment based at least in part on the frequency of occurrence. The method further includes generating a revised point cloud, the revised point cloud comprising points that form the upper boundary, points that form the lower boundary, and points between the upper boundary and the lower boundary, wherein the revised point cloud excludes points above the upper boundary and points below the lower boundary.

In another embodiment, a processing system is provided. The processing system includes a memory comprising computer readable instructions and a processing device for executing the computer readable instructions. The computer readable instructions control the processing device to perform operations for removing an unwanted point from a point cloud of an environment. The operations include grouping points of the point cloud based on a frequency of occurrence of the points relative to a vertical axis defined for the environment. The operations further include identifying a first set of points of the point cloud corresponding to an upper boundary of the environment based at least in part on the frequency of occurrence. The operations further include identifying a second set of points of the point cloud corresponding to a lower boundary of the environment based at least in part on the frequency of occurrence. The operations further include generating a revised point cloud, the revised point cloud comprising points that form the upper boundary, points that form the lower boundary, and points between the upper boundary and the lower boundary, wherein the revised point cloud excludes points above the upper boundary and points below the lower boundary.

In yet another embodiment, a system is provided. The system includes a three-dimensional (3D) coordinate measurement device to capture a point cloud of an environment. The system further includes a processing system communicatively coupled to the 3D coordinate measurement device. The processing system includes a memory comprising computer readable instructions and a processing device for executing the computer readable instructions. The computer readable instructions control the processing device to perform operations for removing an unwanted point from the point cloud of the environment. The operations include grouping points of the point cloud based on a frequency of occurrence of the points relative to a vertical axis defined for the environment. The operations further include identifying a first set of points of the point cloud corresponding to an upper boundary of the environment based at least in part on the frequency of occurrence. The operations further include identifying a second set of points of the point cloud corresponding to a lower boundary of the environment based at least in part on the frequency of occurrence. The operations further include generating a revised point cloud, the revised point cloud comprising points that form the upper boundary, points that form the lower boundary, and points between the upper boundary and the lower boundary, wherein the revised point cloud excludes points above the upper boundary and points below the lower boundary. The above features and advantages, and other features and advantages, of the disclosure are readily apparent from the following detailed description when taken in connection with the accompanying drawings.

### BRIEF DESCRIPTION OF DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 depicts a perspective view of a laser scanner according to one or more embodiments described herein;

FIG. 2 depicts a side view of the laser scanner illustrating a method of measurement according to one or more embodiments described herein;

FIG. 3 depicts a schematic illustration of the optical, mechanical, and electrical components of the laser scanner according to one or more embodiments described herein;

FIG. 4 depicts a schematic illustration of the laser scanner of FIG. 1 according to one or more embodiments described herein;

FIG. 5 depicts a schematic illustration of a processing system for removing unwanted points from point clouds according to one or more embodiments described herein;

FIG. 6A depicts a point cloud of an environment and an enlarged portion of the point cloud of the environment according to one or more embodiments described herein;

FIG. 6B depicts the point cloud of FIG. 6A arranged relative to a z-axis and a corresponding histogram according to one or more embodiments described herein;

FIG. 6C depicts graphs corresponding to the histogram of FIG. 6B according to one or more embodiments described herein;

FIG. 6D depicts a point cloud with points representing the floor and ceiling of the environment and points above the floor or below the ceiling being omitted as unwanted points according to one or more embodiments described herein;

FIG. 6E depicts a weighting approach for scoring and identifying vertical structure candidates within the environment according to one or more embodiments described herein;

FIG. 6F depicts a point cloud according to one or more embodiments described herein;

FIG. 6G depicts a floor plan created using vertical structures detected based on the point cloud of FIG. 6F according to one or more embodiments described herein;

FIG. 7 depicts a flow diagram of a method for removing unwanted points from point clouds according to one or more embodiments described herein; and

FIG. 8 depicts a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Generating an image uses at least three values for each data point. These three values include the distance and two angles, or are transformed values, such as the x, y, z coordinates. In an embodiment, an image is also based on a fourth gray-scale value, which is a value related to irradiance of scattered light returning to the scanner.

Some TOF scanners direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the camera digital images to an operator of the laser scanner. By viewing the camera images, the operator of the scanner determines the field of view of the measured volume and adjust settings on the laser scanner to measure over a larger or smaller region of space. In addition, in some embodiments, the camera digital images are transmitted to a processor to add color to the scanner image. To generate a color scanner image, at least three positional coordinates (such as x, y, z) and three color values (such as red, green, blue “RGB”) are collected for each data point.

One application where 3D scanners are used is to scan an environment such as a building or a construction site. In some of these environments there are extraneous objects, such as construction debris for example, that are measured as part of the scan.

Accordingly, while existing 3D coordinate measurement devices are suitable for their intended purposes, what is needed is a 3D coordinate measurement device having certain features of embodiments described herein. It should be appreciated that when certain environments are scanned, the objects within the environment are also scanned and as a result, 3D coordinate points of these object are also scanned. Accordingly, embodiments of this disclosure provide advantages in allowing for the generation of a desired digital representation or model of the environment without including 3D coordinate points of undesired object. Embodiments described herein provide for removing unwanted points from point clouds.

Three-dimensional coordinate measurement devices, such as laser scanners, are used to captured 3D data (e.g., point clouds) about an environment. The 3D data is presented on a device, such as a smartphone, tablet, heads-up display, etc., as a graphical representation. In some cases, it is desirable to register the 3D data of the environment with a model of the environment. The model takes any suitable form, such as a computer aided design (CAD) model, floor plan, blue print, building information modeling (BIM) model, and/or the like including combinations and/or multiples thereof.

The 3D data (e.g., point cloud) obtained by the 3D coordinate measurement device includes undesired data (e.g., points). Such undesired data includes noise, artifacts, objects within the environment, and/or the like including combinations and/or multiples thereof. For example, in a construction site, construction debris (e.g., scraps of materials, staged materials, work waste, temporary working objects such as tools or machinery, and/or the like including combinations and/or multiples thereof) are present. When a scan of the construction site is performed, the construction debris (or other similar objects) are captured in the scan. Points corresponding to such construction debris or other similar objects are examples of unwanted points of the 3D data (e.g., point cloud). Since the construction debris (or other similar objects) are likely not modeled in the model of the environment, the unwanted points cause complications when registering the 3D data of the environment with the model of the environment.

Embodiments described herein provide for removing unwanted points from point clouds. Particularly, one or more embodiments described herein relate to extracting structures from 3D data, such as point clouds, where the extracted structures contain a relatively high density and distribution of points along a vertical axis (e.g., a z-axis). Such a vertical axis is indicative of substantially vertical structures in an environment, such as walls, pillars, and/or the like including combinations and/or multiples thereof. By extracting unwanted points from a point cloud of an environment, the point cloud is more easily and more accurately registered with a model of the environment. For example, by removing unwanted points from the point cloud of the environment where the unwanted points correspond to objects, such as construction debris, that are not included in the model of the environment, the point cloud more accurately corresponds to the model, which improves point cloud-to-model registration.

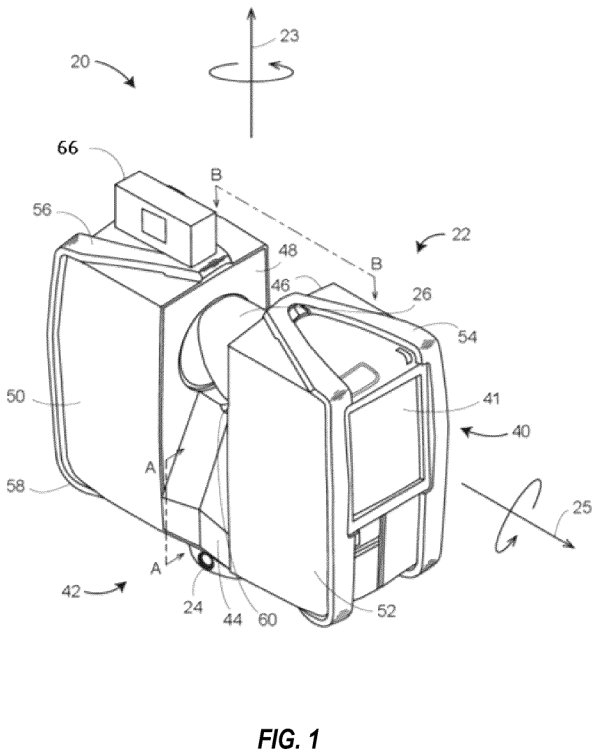

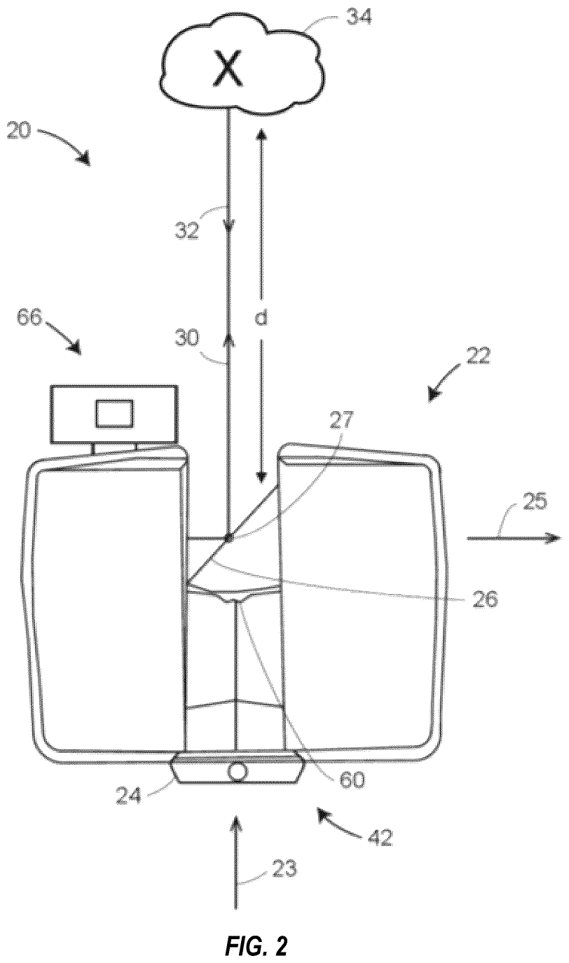

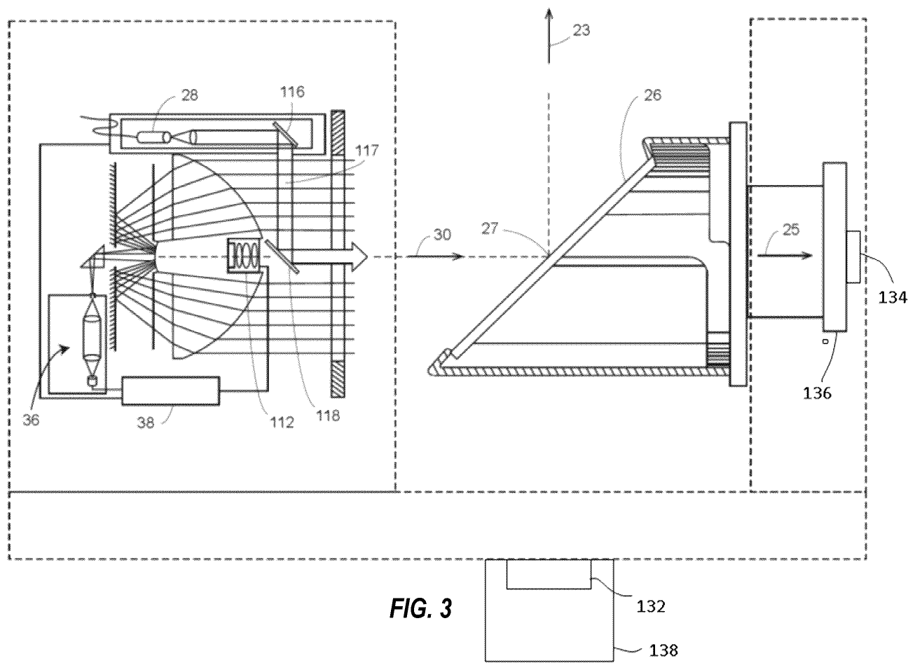

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which is rotated about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis are substituted for the terms vertical axis and horizontal axis, respectively. In some embodiments, the term pan axis or standing axis is also used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. In some embodiments, the laser beam has a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths are also used in some embodiments. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 also collects gray-scale information related to the received optical power (equivalent to the term “brightness.”) The gray-scale value is determined at least in part, for example, by integration of the bandpass-filtered and amplified signal in the light receiver 36 over a measuring period attributed to the object point X.

The measuring head 22 includes a display device 40 integrated into the laser scanner 20. The display device 40 includes a graphical touch screen 41, as shown in FIG. 1, which allows the operator to set the parameters or initiate the operation of the laser scanner 20. For example, the screen 41 has a user interface that allows the operator to provide measurement instructions to the device, and the screen also displays measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 are coupled to the traverse 42, the walls 46, 48 and the shells 50, 54 at multiple locations in some embodiments.

The pair of yokes 54, 56 cooperate to circumscribe a convex space within which the two shells 50, 52 are arranged. In the embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depend on signal strength, which is measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 is a device that captures and measures a parameter associated with the scanned area or the scanned object and provides a signal representing the measured quantities over an image acquisition area. The auxiliary image acquisition device 66 includes, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 emits a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

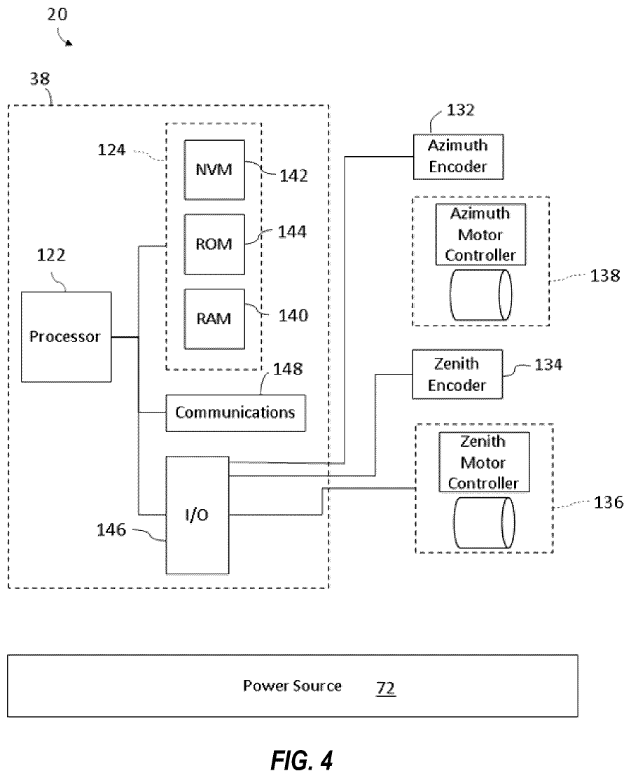

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors include microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 includes one or more LEDs (light-emitting diodes) 82, an LCD (liquid-crystal diode) display, a CRT (cathode ray tube) display, a touch-screen display or the like. A keypad is also coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 is also coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet Protocol), RS-232, ModBus, and/or the like including combinations and/or multiples thereof. Additional systems 20 is also connected to LAN with the controllers 38 in each of these systems 20 being configured to send and receive data to and from remote computers and other systems 20. The LAN is connected to the Internet. This connection allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software is encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device is another type of system that measures a plurality of points on surfaces (i.e., generates a point cloud), such as but not limited to a triangulation scanner, a structured light scanner, a photogrammetry device, a light detection and ranging (LIDAR) device, and/or the like including combinations and/or multiples thereof, for example.

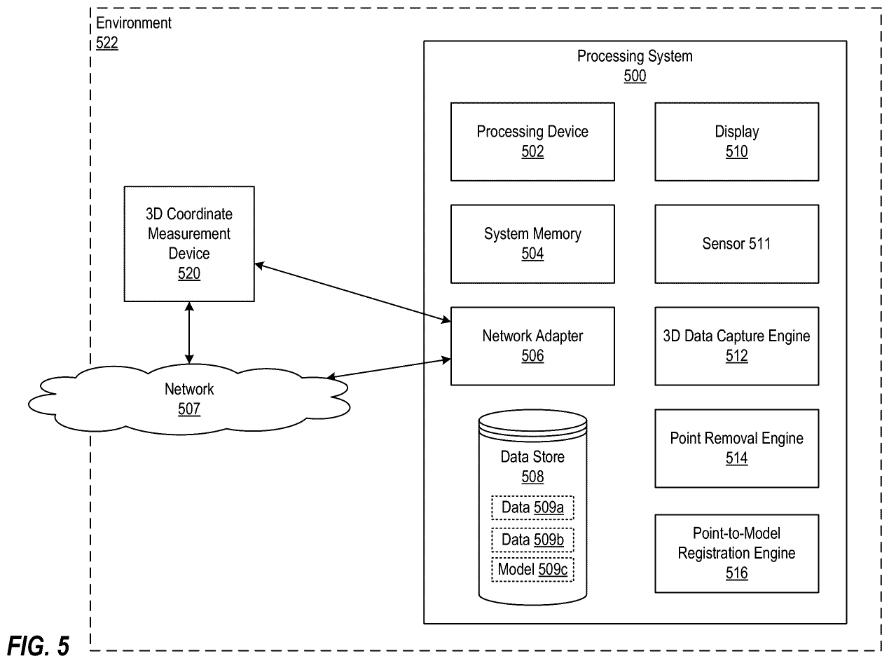

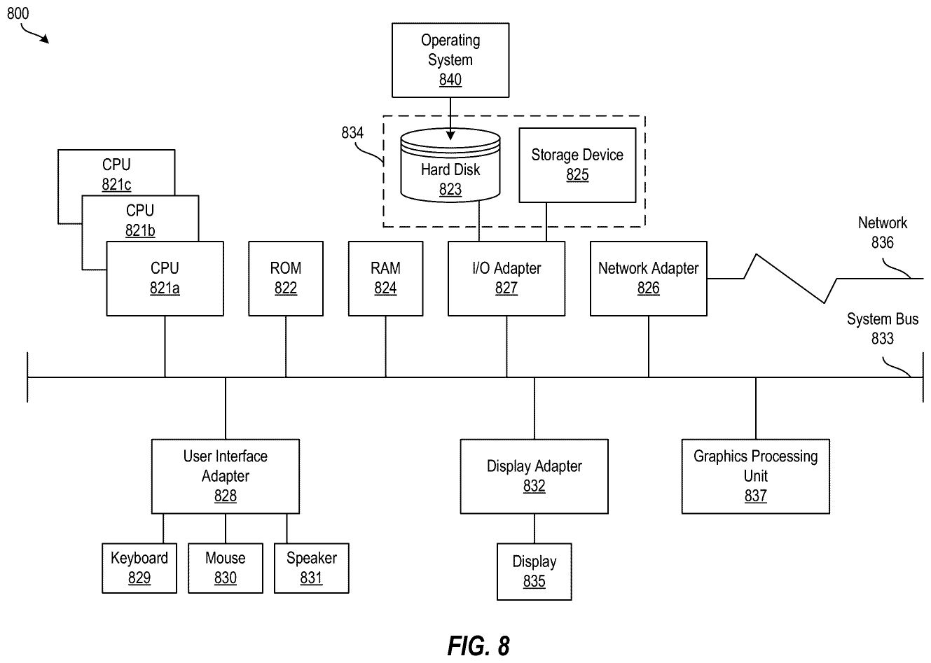

FIG. 5 is a schematic illustration of a processing system 500 for removing unwanted points from point clouds according to one or more embodiments described herein. In some embodiments, the processing system 500 is any suitable computing device, such as a laptop computer, a desktop computer, a smartphone, a tablet computer, and/or the like, including combinations and/or multiples thereof. FIG. 8 depicts a processing system 800, which is an example of the processing system 500. As shown in FIG. 5, the processing system 500 includes a processing device 502 (e.g., one or more of the processing devices 821 of FIG. 8), a system memory 504 (e.g., the RAM 824 and/or the ROM 822 of FIG. 8), a network adapter 506 (e.g., the network adapter 826 of FIG. 8), a data store 508, a display 510, a 3D data capture engine 512, a point removal engine 514, and a point-to-model registration engine 516.

The various components, modules, engines, etc. described regarding FIG. 5 (e.g., the 3D data capture engine 512, the point removal engine 514, and the point-to-model registration engine 516) are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein is a combination of hardware and programming. The programming includes processor executable instructions stored on a tangible memory, and the hardware includes the processing device 502 for executing those instructions. Thus, the system memory 504 stores program instructions that when executed by the processing device 502 implement the engines described herein. Other engines are also utilized to include other features and functionality described in other examples herein.

The network adapter 506 enables the processing system 500 to transmit data to and/or receive data from other sources, such as a 3D coordinate measurement device 520. For example, the processing system 500 receives data (e.g., a data set that includes a plurality of three-dimensional coordinates of an environment 522) from the 3D coordinate measurement device 520 directly and/or via a network 507. The data from the 3D coordinate measurement device 520 is stored in the data store 508 of the processing system 500 as data 509a, which is a point cloud for example. According to one or more embodiments described herein, the 3D data capture engine 512 causes the 3D coordinate measurement device 520 to capture the 3D data about the environment, such as by sending a command to the 3D coordinate measurement device 520 to initiate the capturing, sending properties or parameters to the 3D coordinate measurement device 520 to define how the capturing is performed, and/or the like including combinations and/or multiples thereof. According to one or more embodiments described herein, the 3D data capture engine 512 uses a sensor 511 (e.g., a camera, a panoramic camera, a 360-degree camera, a light detection and ranging (LIDAR) sensor, and/or the like, including combinations and/or multiples thereof), to capture additional information about the environment 522 as data 509b, which includes 3D data, images, video, and/or the like including combinations and/or multiples thereof. According to one or more embodiments described herein, the processing system 500 also stores in the data store 508 a model 509c of the environment 522. The model 509c includes a CAD model, a BIM model, and/or the like including combinations and/or multiples thereof.

The network 507 represents any one or a combination of different types of suitable communications networks such as, for example, cable networks, public networks (e.g., the Internet), private networks, wireless networks, cellular networks, or any other suitable private and/or public networks. Further, in some embodiments, the network 507 has any suitable communication range associated therewith and includes, for example, global networks (e.g., the Internet), metropolitan area networks (MANs), wide area networks (WANs), local area networks (LANs), or personal area networks (PANs). In addition, in some embodiments, the network 507 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The 3D coordinate measurement device 520 (e.g., a laser scanner) is arranged on, in, and/or around the environment 522 to scan the environment 522. It should be appreciated that while embodiments herein refer to a 3D coordinate measurement device as a laser scanner (e.g., the 3D coordinate measurement device 520), this is for example purposes and the claims should not be so limited. In other embodiments, other types of optical measurement devices are used, such as but not limited to triangulation scanners and structured light scanners for example.

According to one or more embodiments described herein, the 3D coordinate measurement device 520 includes a scanner processing system including a scanner controller, a housing, and a 3D scanner. The 3D scanner is disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The 3D coordinate measurement device 520 performs at least one scan to generate a data set that includes a plurality of three-dimensional coordinates of the environment 522. The data set is transmitted, directly or indirectly (such as via the network 507) to a processing system, such as the processing system 500, which stores the data set as the data 509a in the data store 508. It should be appreciated that other numbers of scanners (e.g., two scanner, three scanners, four scanners, six scanners, eight scanners, etc.) are used in some embodiments. According to one or more embodiments described herein, one or more scanners are used to take multiple scans. For example, the 3D coordinate measurement device 520 captures first scan data at a first location and then be moved to a second location, where the 3D coordinate measurement device 520 captures second scan data.

Using the data (e.g., the data 509a) received from the 3D coordinate measurement device 520 and/or the data (e.g., the data 509b) captured by the sensor 511, the processing system 500 generates and stores a point cloud. The point cloud is registered to the model 509c. As described herein, in some embodiments, the point cloud includes one or more unwanted points, such as due to unexpected objects within the environment 522 during capturing the 3D data. The unwanted points in the point cloud cause aligning the point cloud to the model 509c to be difficult. To address this shortcoming, the processing system 500 implements a point removal engine 514 for removing unwanted points in the point cloud.

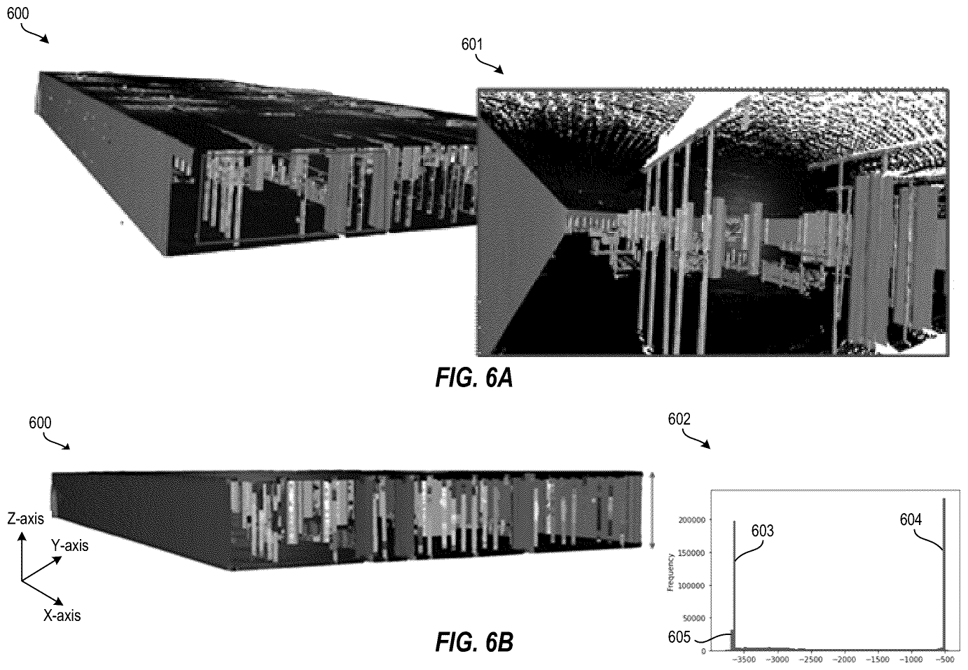

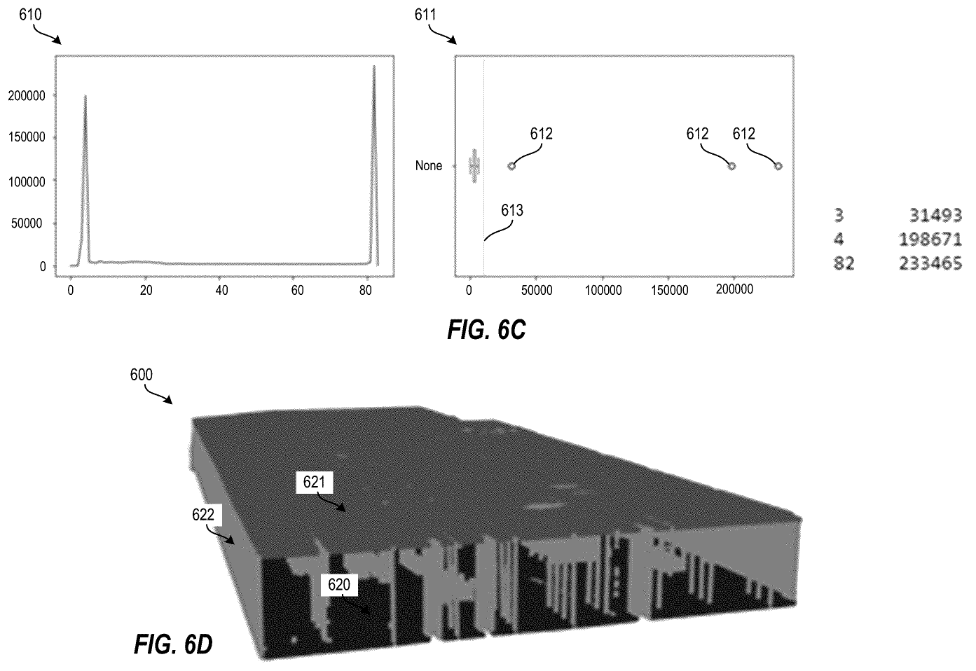

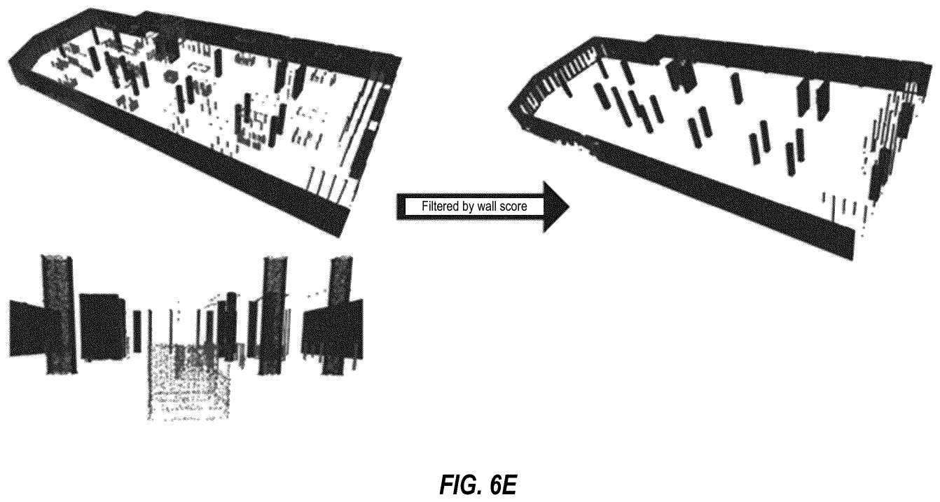

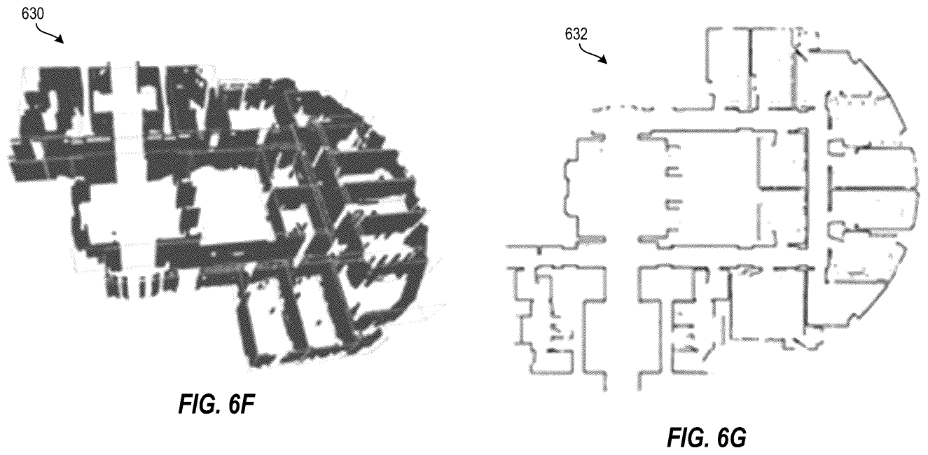

The point removal engine 514 analyzes points of the point cloud in a vertical axis (e.g., z-axis) distribution. For example, FIG. 6A depicts a point cloud 600 of an environment (e.g., the environment 522) and an enlarged portion 601 of the point cloud 600 of the environment. The objective of analyzing the points of the point cloud (e.g., the point cloud 600) in the vertical axis is to identify cutoff limits of vertical axis (e.g., z-axis) peaks (also referred to as “Z peaks”). The point removal engine 514 identifies a ceiling (e.g., an upper boundary) and a floor (e.g., a lower boundary) for the point cloud 600. To do this, in some embodiments, the point removal engine 514 identifies probability bins that are defined by two planes of interest, namely a first plane along the x-y axes defining the floor and a second plane along the x-y axes defining the ceiling. The point removal engine 514 groups or (“bins”) points based on their vertical (e.g., z-axis) value. For example, FIG. 6B shows the point cloud 600 arranged relative to a z-axis according to one or more embodiments described herein. FIG. 6B also shows a histogram 602 for points of the point cloud 600 plotted as a frequency (vertical axis of the histogram 602) relative to a z-axis position (horizontal axis of the histogram 602). The histogram 602 includes a first peak 603 and a second peak 604 that are bins that represent the floor and ceiling, respectively, of the environment corresponding to the point cloud 600. In some embodiments, the histogram 602 also includes extra (e.g., unwanted) points above the ceiling or below the floor on a given point cloud. For example, the histogram 602 includes a third peak 605 that represents points below the floor represented by the first peak 603.

To perform the binning, the point removal engine 514 uses an outlier threshold based approach to identify the relatively largest peaks and an associated histogram index for each of the identified relatively largest peaks. One such approach to identify the relatively largest peaks is the Tukey's fences approach. Once the peak candidates are identified (e.g., the first peak 603, the second peak 604, and the third peak 605 as shown in the histogram 602), noisy data points are clustered and eliminated. In this example, the third peak 605 represents the noisy data points, which are unwanted points of the point cloud 600. To perform the clustering and elimination of such noisy points, the point removal engine 514 clusters the histogram index for each of the identified relatively largest peaks using KMeans clustering or another suitable clustering technique. Since the cluster label varies, the point removal engine 514 then infers a cluster label relation with floor/ceiling by a group by over the index cluster and aggregating the mean index value and max z count. This new index mean value is sorted, and the floor and ceiling histogram indexes are retrieved by getting the index for that z-count. This is shown in FIGS. 6C and 6D. Particularly, FIG. 6C shows graphs 610, 611 corresponding to the histogram 602 according to one or more embodiments described herein. The graph 610 shows a kernel density estimator (KDE) for the Z distribution according to one or more embodiments described herein. The graph 610 provides for visualizing Z peaks, for example. The graph 611 shows a boxplot of the histogram values of the histogram 602 according to one or more embodiments described herein. In this example, three outliers 612 are shown, which correspond to the peaks (e.g., the first peak 603, the second peak 604, and the third peak 605) of the histogram 602. According to one or more embodiments described herein, the outliers 612 are generated using the Tukey's fences threshold 613. Knowing the edge values of each bin, the points that are associated with the floor and ceiling bins are indicated. That is, the point removal engine 514 generates a graphical representation of the point cloud where the upper portion and the lower portion are visually distinct from other points of the point cloud. For example, the point cloud 600 is shown in FIG. 6D where the points 620 represent the floor, the points 621 represent the ceiling, and the remaining points 622 represent other than the floor or ceiling.

In some embodiments, a similar approach is applied for the x and y dimensions as they serve as x and y limits of the z distribution analysis. For that, minimum and maxim bound values of the dimensions (except for z that is now filtered for floor to ceiling) are selected. A linear space is created with a given bin size. With that vector, the point removal engine 514 assigns each point in its x, y, and z bin. The resulting data is added to a table that is manipulated to group and aggregate the dimension bins that result in a number of unique z bins for each x, y bin combination. The point removal engine 514 normalizes the unique z bins by dividing by a maximum number of z bins. As a result, the point removal engine 514 defines a z density for each x,y bin combination. This metric is used to compute x, y vertical structure candidates. The z density provides information about how many z bins exist in a maximum possible number of z bins. In some situations, a substantial number of points of the point cloud are near one of the edges (e.g., floor or ceiling) and empty space in between given by false “good” density.

To provide higher relevance to near ceiling bins, the point removal engine 514 creates a weighted logarithmic space. The weighting is adjusted by a factor parameter. According to an embodiment, as the factor parameter increases, more importance is given to bins near the ceiling. This weight is used as a second metric to score and identify vertical structure candidates as shown in FIG. 6E. According to an embodiment, as the factor parameter decreases, more importance is given to bins rear the floor.

The techniques described herein for removing unwanted points are used for point cloud registration, floor planning, and other use cases. For example, the point-to-model registration engine 516 registers the point cloud (e.g., the point cloud 600) to a model of the environment (e.g., the model 509c of the environment 522). One approach is to use the Super4PCS approach, which is an optimal linear time output-sensitive global alignment algorithm that registers a pair of raw point clouds in arbitrary initial poses. The processing system 500 also creates a floor plan from a given point cloud. The techniques described herein are used to detect vertical structures (e.g., walls, pillars, and/or the like including combinations and/or multiples thereof) used to create the floor plan. For example, as shown in FIG. 6F, a point cloud 630 is captured as described herein, and the techniques described herein are applied to detect vertical structures within the environment in which the point cloud 630 was captured. A floor plan 632, shown in FIG. 6G, is then created using the vertical structures detected based on the point cloud 630.

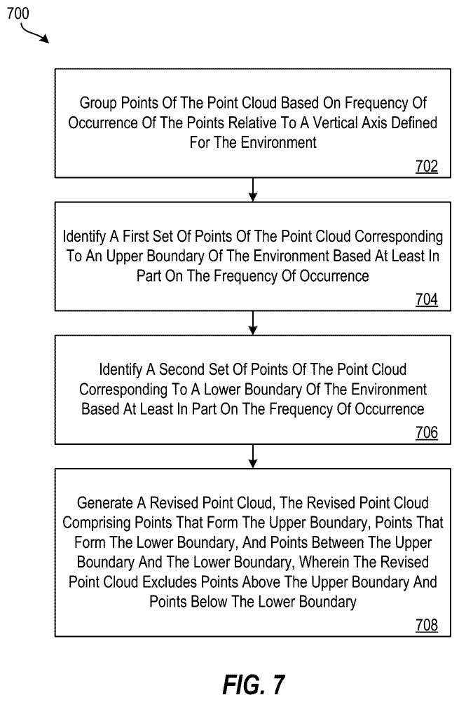

Further features and functionality of the point removal engine 514 are now described in more detail with reference to FIG. 7, which depicts, a flow diagram of a method 700 for removing unwanted points from point clouds is provided according to embodiments described herein. In some embodiments, the method 700 is performed by any suitable system/device, such as the processing system 500 of FIG. 5 and/or the processing system 800 of FIG. 8. FIG. 7 is now described in more detail with reference to FIG. 5 but is not so limited.

At block 702, the point removal engine 514 groups points of the point cloud based on frequency of occurrence of the points relative to a vertical axis defined for the environment. For example, the points of the point cloud are grouped as shown in the histogram 602 of FIG. 6B.

At block 704, the point removal engine 514 identifies a first set of points of the point cloud corresponding to an upper boundary (e.g., ceiling) of the environment based at least in part on the frequency of occurrence. At block 706, the point removal engine 514 identifies a second set of points of the point cloud corresponding to a lower boundary of the environment based at least in part on the frequency of occurrence. As described herein, the first set of points and/or the second set of points is identified using a binning approach using the histogram 602 of FIG. 6B. For example, identifying the first set of points and identifying the second set of points are performed by generating a histogram of the frequency of occurrence of the points relative to the vertical axis. According to embodiments described herein, identifying the first set of points and identifying the second set of points is performed using a Tukey's fences approach. According to embodiments described herein, the first set of points defines a first plane, and the second set of points defines a second plane substantially parallel to the first plane.

At block 708, the point removal engine 514 generates a revised point cloud, the revised point cloud comprising points that form the upper boundary, points that form the lower boundary, and points between the upper boundary and the lower boundary, wherein the revised point cloud excludes points above the upper boundary and points below the lower boundary.

According to embodiments described herein, the method 700 further includes performing point cloud registration to register the revised point cloud to a model of the environment as described herein. The model includes a CAD model, a BIM model, a floor plan, a blue print, and/or the like including combinations and/or multiples thereof.

According to embodiments described herein, the method 700 further includes generating a floor plan using the revised point cloud.

According to embodiments described herein, the method 700 includes generating a graphical representation of the revised point cloud.

Additional processes are also included, and it should be understood that the process depicted in FIG. 7 represents an illustration, and that other processes are added, existing processes are removed, modified, and rearranged without departing from the scope of the present disclosure.

It is understood that embodiments described herein is capable of being implemented in conjunction with any other type of computing environment now known/later developed. For example, FIG. 8 depicts a block diagram of a processing system 800 for implementing the techniques described herein. In accordance with embodiments described herein, the processing system 800 is an example of a cloud computing node of a cloud computing environment. In examples, processing system 800 has at least one central processing unit (e.g. “processors,” “processing resources,” and “processing devices”) 821a, 821b, 821c, etc. (collectively and generically referred to as processor(s) 821 and/or as processing device(s)). In aspects of the present disclosure, each processor 821 includes a reduced instruction set computer (RISC) microprocessor. Processors 821 are coupled to system memory (e.g., random access memory (RAM) 824) and various other components via a system bus 833. Read only memory (ROM) 822 is coupled to system bus 833 and includes a basic input/output system (BIOS), which controls certain basic functions of processing system 800.

Further depicted are an input/output (I/O) adapter 827 and a network adapter 826 coupled to system bus 833. I/O adapter 827 is a small computer system interface (SCSI) adapter that communicates with a hard disk 823, a storage device 825 and any other similar component. I/O adapter 827, hard disk 823, and storage device 825 are collectively referred to herein as mass storage 834. Operating system 840 for execution on processing system 800 is stored in mass storage 834. The network adapter 826 interconnects system bus 833 with an outside network 836 enabling processing system 800 to communicate with other such systems.

A display (e.g., a display monitor) 835 is connected to system bus 833 by display adapter 832, which includes a graphics adapter to improve the performance of graphics intensive applications and a video controller. In one aspect of the present disclosure, adapters 826, 827, and/or 832 are connected to at least one I/O bus that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 are interconnected to system bus 833 via user interface adapter 828, which includes, for example, a Super I/O chip integrating multiple device adapters into a single integrated circuit.

In some aspects of the present disclosure, processing system 800 includes a graphics processing unit 837. Graphics processing unit 837 is a specialized electronic circuit designed to manipulate and alter memory to accelerate the creation of images in a frame buffer intended for output to a display. In general, graphics processing unit 837 is very efficient at manipulating computer graphics and image processing, and has a highly parallel structure that makes it more effective than general-purpose CPUs for algorithms where processing of large blocks of data is done in parallel.

Thus, as configured herein, processing system 800 includes processing capability in the form of processors 821, storage capability including system memory (e.g., RAM 824), and mass storage 834, input means such as keyboard 828 and mouse 830, and output capability including speaker 831 and display 835. In some aspects of the present disclosure, a portion of system memory (e.g., RAM 824) and mass storage 834 collectively store the operating system 840 to coordinate the functions of the various components shown in processing system 800.

In addition to the features described herein, or as an alternative, further embodiments of the method include that identifying the first set of points and identifying the second set of points is performed using a Tukey's fences approach.

In addition to the features described herein, or as an alternative, further embodiments of the method include that identifying the first set of points and identifying the second set of points comprises generating a histogram of the frequency of occurrence of the points relative to the vertical axis.

In addition to the features described herein, or as an alternative, further embodiments of the method include that the first set of points defines a first plane, and wherein the second set of points defines a second plane substantially parallel to the first plane.

In addition to the features described herein, or as an alternative, further embodiments of the method include performing point cloud registration to register the revised point cloud to a model of the environment.

In addition to the features described herein, or as an alternative, further embodiments of the method include that the model is a computer aided design model.

In addition to the features described herein, or as an alternative, further embodiments of the method include that the model is a building information modeling model.

In addition to the features described herein, or as an alternative, further embodiments of the method include generating a floor plan using the revised point cloud.

In addition to the features described herein, or as an alternative, further embodiments of the method include generating a graphical representation of the revised point cloud.

In addition to the features described herein, or as an alternative, further embodiments of the method include identifying vertical structure candidates within the environment.

In addition to the features described herein, or as an alternative, further embodiments of the processing system include that identifying the first set of points and identifying the second set of points is performed using a Tukey's fences approach.

In addition to the features described herein, or as an alternative, further embodiments of the processing system include that identifying the first set of points and identifying the second set of points comprises generating a histogram of the frequency of occurrence of the points relative to the vertical axis.

In addition to the features described herein, or as an alternative, further embodiments of the processing system include that the first set of points defines a first plane, and wherein the second set of points defines a second plane substantially parallel to the first plane.

In addition to the features described herein, or as an alternative, further embodiments of the processing system include that the operations further include performing point cloud registration to register the revised point cloud to a model of the environment.

In addition to the features described herein, or as an alternative, further embodiments of the processing system include that the model is a computer aided design model.

In addition to the features described herein, or as an alternative, further embodiments of the processing system include that the model is a building information modeling model.

In addition to the features described herein, or as an alternative, further embodiments of the processing system include that the operations include generating a floor plan using the revised point cloud.

In addition to the features described herein, or as an alternative, further embodiments of the processing system include that the operations include generating a graphical representation of the revised point cloud.

It will be appreciated that embodiments described herein are embodied as a system, method, or computer program product and take the form of a hardware embodiment, a software embodiment (including firmware, resident software, micro-code, etc.), or a combination thereof. Furthermore, one or more embodiments described herein take the form of a computer program product embodied in one or more computer readable medium(s) having computer readable program code embodied thereon.

The term “about” is intended to include the degree of error associated with measurement of the particular quantity based upon the equipment available at the time of filing the application. For example, the term “about” includes a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure is modified to incorporate any number of variations, alterations, substitutions or equivalent arrangements not heretofore described, but which are commensurate with the spirit and scope of the disclosure. Additionally, while various embodiments of the disclosure have been described, it is to be understood that the embodiment(s) include(s) only some of the described aspects. Accordingly, the disclosure is not to be seen as limited by the foregoing description, but is only limited by the scope of the appended claims.

What is claimed is:

1. A method for removing an unwanted point from a point cloud of an environment, the method comprising:
grouping points of the point cloud based on a frequency of occurrence of the points relative to a vertical axis defined for the environment;
identifying a first set of points of the point cloud corresponding to an upper boundary of the environment based at least in part on the frequency of occurrence;
identifying a second set of points of the point cloud corresponding to a lower boundary of the environment based at least in part on the frequency of occurrence; and
generating a revised point cloud, the revised point cloud comprising points that form the upper boundary, points that form the lower boundary, and points between the upper boundary and the lower boundary, wherein the revised point cloud excludes points above the upper boundary and points below the lower boundary.

2. The method of claim 1, wherein identifying the first set of points and identifying the second set of points is performed using a Tukey's fences approach.

3. The method of claim 1, wherein identifying the first set of points and identifying the second set of points comprises generating a histogram of the frequency of occurrence of the points relative to the vertical axis.

4. The method of claim 1, wherein the first set of points defines a first plane, and wherein the second set of points defines a second plane substantially parallel to the first plane.

5. The method of claim 1, further comprising performing point cloud registration to register the revised point cloud to a model of the environment.

6. The method of claim 5, wherein the model is a computer aided design model.

7. The method of claim 5, wherein the model is a building information modeling model.

8. The method of claim 1, further comprising generating a floor plan using the revised point cloud.

9. The method of claim 1, further comprising generating a graphical representation of the revised point cloud.

10. The method of claim 1, further comprising identifying vertical structure candidates within the environment.

11. A processing system comprising:
a memory comprising computer readable instructions; and
a processing device for executing the computer readable instructions, the computer readable instructions controlling the processing device to perform operations for removing an unwanted point from a point cloud of an environment, the operations comprising:
grouping points of the point cloud based on a frequency of occurrence of the points relative to a vertical axis defined for the environment;
identifying a first set of points of the point cloud corresponding to an upper boundary of the environment based at least in part on the frequency of occurrence;
identifying a second set of points of the point cloud corresponding to a lower boundary of the environment based at least in part on the frequency of occurrence; and
generating a revised point cloud, the revised point cloud comprising points that form the upper boundary, points that form the lower boundary, and points between the upper boundary and the lower boundary, wherein the revised point cloud excludes points above the upper boundary and points below the lower boundary.

12. The processing system of claim 11, wherein identifying the first set of points and identifying the second set of points is performed using a Tukey's fences approach.

13. The processing system of claim 11, wherein identifying the first set of points and identifying the second set of points comprises generating a histogram of the frequency of occurrence of the points relative to the vertical axis.

14. The processing system of claim 11, wherein the first set of points defines a first plane, and wherein the second set of points defines a second plane substantially parallel to the first plane.

15. The processing system of claim 11, the operations further comprising performing point cloud registration to register the revised point cloud to a model of the environment.

16. The processing system of claim 15, wherein the model is a computer aided design model.

17. The processing system of claim 15, wherein the model is a building information modeling model.

18. The processing system of claim 11, the operations further comprising generating a floor plan using the revised point cloud.

19. The processing system of claim 11, the operations further comprising generating a graphical representation of the revised point cloud.

20. A system comprising:
a three-dimensional (3D) coordinate measurement device to capture a point cloud of an environment; and
a processing system communicatively coupled to the 3D coordinate measurement device, the processing system comprising:
a memory comprising computer readable instructions; and
a processing device for executing the computer readable instructions, the computer readable instructions controlling the processing device to perform operations for removing an unwanted point from the point cloud of the environment, the operations comprising:
grouping points of the point cloud based on a frequency of occurrence of the points relative to a vertical axis defined for the environment;
identifying a first set of points of the point cloud corresponding to an upper boundary of the environment based at least in part on the frequency of occurrence;
identifying a second set of points of the point cloud corresponding to a lower boundary of the environment based at least in part on the frequency of occurrence; and
generating a revised point cloud, the revised point cloud comprising points that form the upper boundary, points that form the lower boundary, and points between the upper boundary and the lower boundary, wherein the revised point cloud excludes points above the upper boundary and points below the lower boundary.
